(19) United States
(12) Patent Application Publication
(10) Pub. No.: US 2007/0156407 A1
(43) Pub. Date: Jul. 5, 2007

(54) Integrated speech dialog system

(76) Inventor: Manfred Schedl, Durach (DE)

Correspondence Address: BRINKS HOFER GILSON & LIONE, P.O. BOX 10395, CHICAGO, IL, 60610, US

(21) Appl. No.: 11/499,139

(22) Filed: Aug. 3, 2006

(30) Foreign Application Priority Data
Aug. 4, 2005 (EP) 05016999.4

(51) Int. Cl. G10L 15/18

(52) U.S. Cl. 704/257

(57) ABSTRACT

A speech dialog system includes a speech application manager, a message router, service components, and a platform abstraction layer. When a speech command is detected, the speech application manager instructs one or more service components to perform a service. The message router facilitates data exchange between the speech application manager and the service components. The message router includes a generic communication format that may be adapted to a communication format of an application. The platform abstraction layer facilitates platform independent communication between the speech dialog system and one or more target systems.

### BACKGROUND OF THE INVENTION

1. Priority Claim

This application claims the benefit of priority from European Patent Application No. 05016999.4, filed Aug. 4, 2005, which is incorporated by reference.

2. Technical Field

The invention relates to speech controlled systems, and in particular, to a speech dialog system.

3. Related Art

The expansion of voice operated systems into many areas of technology has improved the extensibility and flexibility of such systems. Some larger systems and devices incorporate electronic, mechanical, and other subsystems that are configured to respond to voice commands.

Automobiles include a variety of systems that may operate in conjunction with speech dialog systems, including navigation, DVD, compact disc, radio, automatic garage and vehicle door openers, climate control, and wireless communication systems. It is not uncommon for users to add additional systems that are also configurable for voice operation.

While the development of speech dialog systems has advanced, some current speech dialog systems are limited by specific platforms and exhibit a non-uniform set of interfaces. The Speech Application Program Interface (SAPI) provided by Microsoft, Inc. is limited by to the Microsoft Operating System. While other systems, such as the JAVA SAPI, allows for some platform independence, such as in speech recognition and recording, it does so provided a particular speech server runs in the background. With other speech dialog systems, adaptation to new platforms may involve modification of the kernel.

In light of the rapidly increasing number of integrated systems configured for voice operation, there remains a need for improving the portability, extensibility, and flexibility in speech dialog systems.

### SUMMARY

A speech dialog system includes a speech application manager, a message router, service components, and a platform abstraction layer. When a speech command is detected, the speech application manager may instruct one or more service components to perform a service. The service components may include speech recognition, recording, spell matching, a customer programming interface, or other components. The message router facilitates data exchange between the speech application manager and the multiple service components. The message router includes a generic communication format that may be adapted to a communication format of an application to effectively interface the application to the message router. The platform abstraction layer facilitates platform independent communication between the speech dialog system and one or more target systems.

The speech dialog system may include development and simulation environments that generate and develop new speech dialogs in connection with new or additional requirements. The platform independence provided through the platform abstraction layer and the communication format independence allows the speech dialog system to dynamically develop and simulate new speech dialogs. The speech dialog system may generate a virtual application for simulation or debugging of one or more new speech dialogs, and integrate the speech dialog when the simulations produce the desired results.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a portion of a speech dialog system.

FIG. 2 is a speech dialog system including a PAL and a Speech Application Programming Interface.

FIG. 3 is a speech dialog system including a development environment and a simulation environment.

FIG. 4 is a portion of an integrated speech dialog system that may facilitate adaptation to a customer specific pulse code modulation driver interface.

FIG. 5 is a process involved in the operation of a speech dialog system.

FIG. 6 is a process in which a speech dialog system may control one or more user applications or devices.

FIG. 7 is a process that a speech dialog system may execute when processing,

FIG. 8 is a process in which a speech dialog system may develop and simulate new speech dialogs.

FIG. 9 is a speech dialog system coupled to a speech detection device and a target system.

FIG. 10 is an integrated speech dialog system including a processor and a memory.

### DETAILED DESCRIPTION OF THE PREFERRED EMBODIMENTS

An integrated speech dialog system provides a system that interfaces and controls a wide range of user applications, independent of the platform on which the applications are run. A platform abstraction layer allows the integrated speech dialog system to interface new or additional platforms without requiring porting work. The integrated speech dialog system may also allow for the integration of multiple service components into a single system. Some integrated speech dialog system provides seamless adaptation to new applications through dynamic development and/or simulation of new speech dialogs.

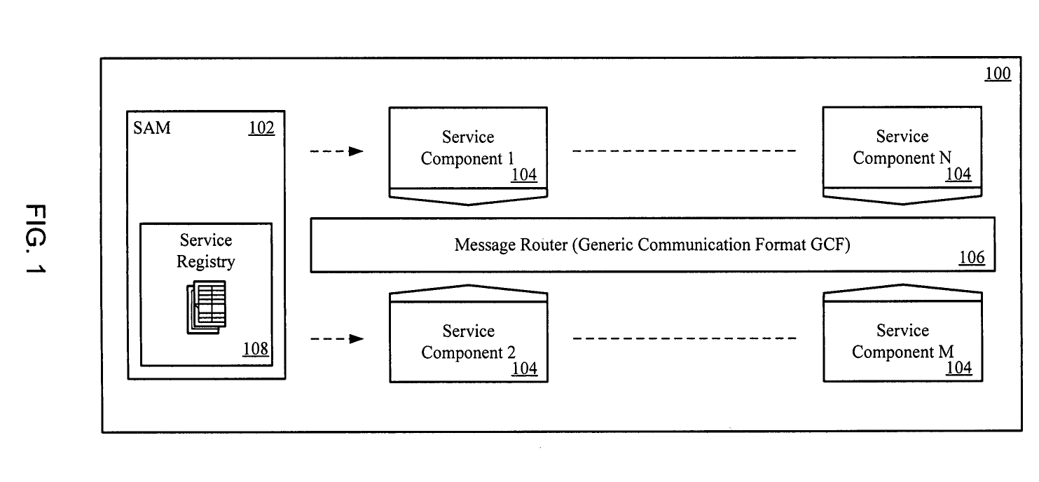

FIG. 1 is a portion of an integrated speech dialog system 100. The integrated speech dialog system 100 includes a speech application manager (SAM) 102 and multiple service components 104. The integrated speech dialog system 100 also includes a message router 106 coupled to the SAM 102 and the multiple service components 104. The integrated speech dialog system 100 may also includes a platform abstraction layer (PAL) that improves portability.

The SAM 102 acts as the control unit of the integrated speech dialog system 100 and comprises a service registry 108. The service registry 108 includes information about the operation of the multiple service components 104. The service registry 108 may include information that associates the appropriate service component 104 with a corresponding database, information that controls the coordinated startup and shutdown of the multiple service components 104, and other information related to the operation of some or each of the multiple service components 104. The integrated speech dialog system 100 may multiplex the multiple service components 104.

The multiple service components 104 may be divided into several units or components. A speech or voice recognition service component represents a common component for controlling a user application or device through the integrated speech dialog system 100 through a verbal utterance. The multiple service components 104 may include speech prompting, speech detection, speech recording, speech synthesis, debug and trace service, a customer programming interface, speech input/output, control of the speech dialog system, spell matcher, a speech configuration database, or other components used in speech signal processing and user application control. The multiple service components 104 may include appropriate databases associated with the services provided by the multiple service components 104.

The message router 106 may provide data exchange between the multiple service components 104, such as between the multiple service components 104 and the SAM 102. The multiple service components 104 may use standardized, uniform, and open interfaces and communication protocols to communicate with the message router 106. Communication between the multiple service components 104 and the SAM 102 may be carried out using a uniform message format as a message protocol. Additional multiple service components 104 may be readily added to the integrated speech dialog system 100 without a kernel modification in the integrated speech dialog system 100.

The message router 106 connects to multiple output channels. The message router 106 may receive a message or data from one of the multiple service components 104 and republish it to a message channel. The message router 106 may route the data using a generic communication format (GCF). Use of a GCF allows the integrated speech dialog system 100 to adapt to changing or additional customer needs. GCF refers to a data format that is independent of the data format of a target system. Using a uniform data format for communication of messages and data between the multiple service components 104 may improve the efficiency of multiplexing multiple service components 104. The data format of the message router 106 may be extensible.

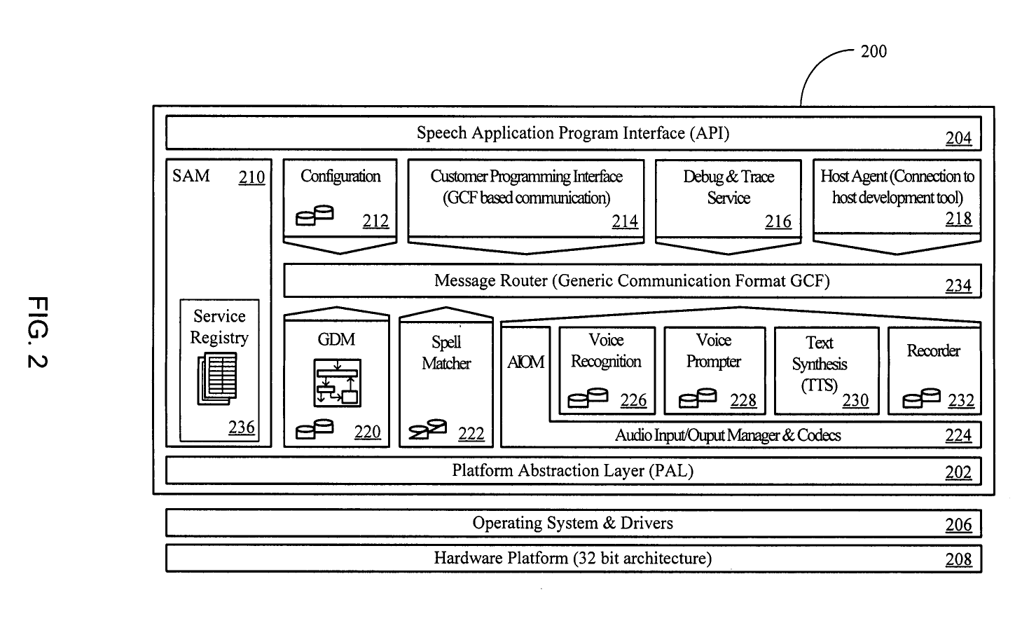

FIG. 2 is an integrated speech dialog system 200 including a PAL 202, a Speech Application Programming Interface (SAPI) 204, and a supporting platform 208. The integrated speech dialog system 200 may include one or more operating systems and drivers 206 running one or more hardware platforms 208. The integrated speech dialog system 200 may be implemented through a 32-bit RISC hardware platform and a 32-bit operating system (OS) and drivers. Other drivers and bit lengths may also be used.

The integrated speech dialog system 200 includes a SAM 210, multiple service components 212-232, and a message router 234. The integrated speech dialog system 200 also includes the PAL 202 for communication between the integrated speech dialog system 200 and one or more target systems. The SAM 210 includes a service registry 236 that may contain information that associates appropriate service components with one or more databases and other information. The message router 234 may use a GCF to facilitate data exchange between the SAM 210 and the multiple service components 212-232 and between the multiple service components 212-232.

The multiple service components 212-232 may include records of information about separate items and particular addresses of a record or a configuration database 212. The multiple service components may include a customer programming interface 214 that enables communication, debug and trace service 216, and a host agent connection service 218. The multiple service components may also include a general dialog manager (GDM) 220, spell matcher 222, and audio input/output manager and codecs 224. The audio input/output manager and codecs 224 may manage elements of the user-to-computer speech interaction through a voice recognition 226, voice prompter 228, text synthesis 230, recorder 232, or other service components. The audio input/output manager and codecs 224 may be hardware or software that compresses and decompresses audio data.

The GDM 220 may include a runtime component executing the dialog flow. The GDM 220 may be a StarRec® General Dialog Manager (StarRec® GDM). Speech applications to be managed by the GDM 220 may be encoded in an XML-based Generic Dialog Modeling Language (GDML). The GDML source files are compiled with a GDC grammar compiler into a compact binary representation, which the GDM 220 may interpret during runtime.

The StarRec® GDM is a virtual machine that interprets compiled GDML applications. It may run on a variety of 32 bit RISC (Integer and/or Float) processors on a realtime operating system. Supported operating systems may include, but are not limited to, VxWorks, QNX, WinCE, and LINUX. Due to the platform-independent implementation of the StarRec® GDM, or other GDM software, porting to other target platforms may be readily realized.

The multiple service components 212, 214, 216, and 218 may represent the functionality of the Speech Application Program Interface (SAPI) 204. The configuration database 212 provides a file based configuration of some or each of the multiple service components 212-232. The configuration database 212 may be initiated by the SAM 210. The customer programming interface 214 facilitates communication to programs that assist the performance of specific tasks. To facilitate this communication, the GCF may be converted outside of the software kernel of the integrated speech dialog system 200 to the formats employed by one or more user applications. In particular, a GCF string interface may be mapped to a user's application system. Mapping to any other communication protocol outside the kernel may be achieved through Transmission Control Protocol/Internet Protocol (TCP/IP), Media Oriented Systems Transport (MOST), Inter-Integrated Circuit (I2C), Message Queues, or other transport protocols. These protocols may allow a user application to connected to the message router 234.

The debug and trace service 216 and the host agent 218 provides a development and debugging GCF interface for development of the integrated speech dialog system 200 and/or for integrating with one or more target system. The GDM 220 may connect to a target system through the host agent 218. The GDM 220 may be use for developing and debugging speech dialogs.

The developed speech dialogs may be a unitary part of or combined in the integrated speech dialog system 200 without conceptual modifications. The integrated speech dialog system 200 may use a simulation environment to determine whether a developed speech dialog is performing successfully. Components of the speech dialogs can also be incorporated in the target system. In this use, the integrated speech dialog system 200 has a cross development capability with a rapid prototyping and seamless host-target integration.

The PAL 202 may facilitate adaptation of the integrated speech dialog system 200 into a target system. The PAL 202 enables the integrated speech dialog system 200 to communicate with any target system having a variety of hardware platforms, operating systems, device drivers, or other hardware or software. In some systems the PAL 202 enables communication by the integrated speech dialog system 200 to arbitrary bus architectures. If used in a device or structure that transports a person or thing, e.g., a vehicle, the integrated speech dialog system 200 may connect via the PAL 202 to many data buses, including Controller Area Network (CAN), MOST, Inter Equipment Bus (IEBus), Domestic Digital Bus (D2B), or other automobile bus architectures. The PAL 202 also allows for the implementation of communication protocols including TCP/IP, Bluetooth, GSM, and other protocols. Different types and classes of devices and components may be called from the integrated speech dialog system 200 through the PAL 202, such as memory, data ports, audio and video outputs, and, switches, buttons, or other devices and components. The PAL 202 allows for implementation of the integrated speech dialog system 200 that is independent of the operating system or architecture of the target system.

In particular, the PAL 202 may source out of the kernel of the integrated speech dialog system 200 dependencies of the integrated speech dialog system 200 on target systems. The PAL 202 communicates between the kernel of the integrated speech dialog system 200, such as the multiple service components 212-232, and the software of one or more target system. In this manner, the PAL 202 allows for a convenient and a simple adaptation of the integrated speech dialog system 200 to an arbitrary target system that is independent of the platform used by the target system.

The abstraction from dependencies on target systems and a uniform GCF allows for simple implementation of third party software. Integration of third party software may occur by an abstraction from the specific realization of the third party interfaces and by mapping of the third party design to the interfaces and message format used by the integrated speech dialog system 200.

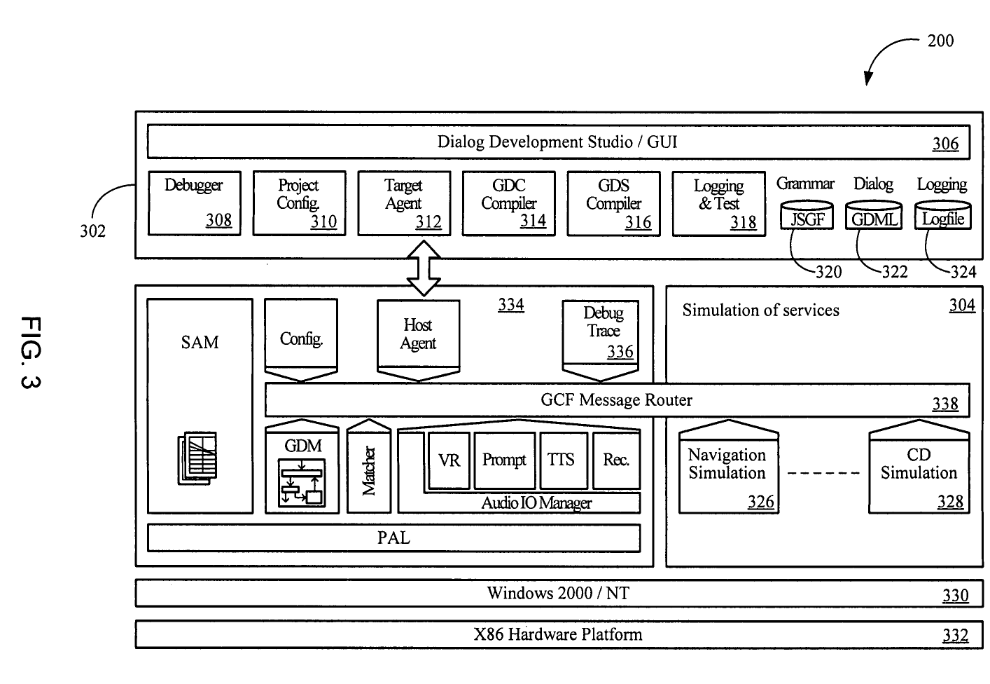

FIG. 3 is an integrated speech dialog system 300 including a development environment 302 and a simulation environment 304. The integrated speech dialog system 300 has an integrated cross-development tool chain services that may develop speech dialogs using a development environment 302 and a simulation environment 304. The development environment 302 may use a dialog development studio (DDS) 306. The DSS may include a debugging unit 308, project configuration unit 310, host agent 312, GDC compiler 314, GDS compiler 316, and/or a unit for logging and testing 318. The GDS compiler 316 may be a compiler for the standardized object orientated language ADA. The DDS 306 may include grammar databases, such as databases operating in a Java Speech Grammar Format (JSGF) 320; databases used with dialog development, such as a GDML database 322; and a database for logging 324.

The databases may be a collection of data arranged to improve the ease and speed of retrieval. In some systems, records comprising information about items may be stored with attributes of a record. The JSGF may be a platform-independent, vendor-independent textual representation of grammars for general use in speech recognition that adopts the style and conventions of the Java programming language, and in some systems includes traditional grammar notations. The simulation environment 304 may include simulations of speech dialogs for user applications. A simulation may be a navigation simulation 326 or a CD simulation 328.

In FIG. 3, an X86 hardware platform 330 may implement a Windows 2000/NT operation system 332. Block 334 includes components of an integrated speech dialog system, including a debug and trace service 336 and a message router 338. The target agent 312 of the DDS 306 connects through a TCP/IP or other transport protocol to host agent 336.

The DDS 306 may be a dialog development tool, such as the StarRec® Dialog Development Studio (StarRec® DDS). StarRec® DDS or other dialog development tool may facilitate the definition, compilation, implementation and administration of new speech dialogs through a graphical user interface. The DDS 306 may allow interactive testing and debugging compiled GDML dialogs 322 in a cross-platform development environment 302. The development environment 302 may be configured to integrate the integrated speech dialog system 300 without any modifications of this system (single source principle).

Seamless migration to target platforms may be achieved through a modular software architecture. The modular architecture may include a main DDS program 306 and may use a TCP/IP-based inter-process communication to exchange messages and data between one or more service components. The service components may be implemented independently of hardware and operating system and may be ported to any type of platform.

The integrated speech dialog system 300 may also include a simulation environment 304 that simulates user applications and/or devices operated or designed to be operated by the integrated speech dialog system 300. In a vehicle, the user applications may include a navigation device, CD player, or other applications such as radio, DVD player, climate control, interior lighting, or a wireless communication application. In developing speech dialogs for controlling components to be added in the future, simulating components may identify potential or actual data conflicts before the application before it is physically implemented.

The DDS 306 may also facilitate the simulation of service components not yet implemented in the integrated speech dialog system. The GCF message router 338 may facilitate the exchange of information between the DDS 306 and simulation environment 338. Integration of a navigation device and a CD player may be simulated. After the respective dialogs are successfully developed, real physical devices can be connected to and controlled by the integrated speech dialog system 300.

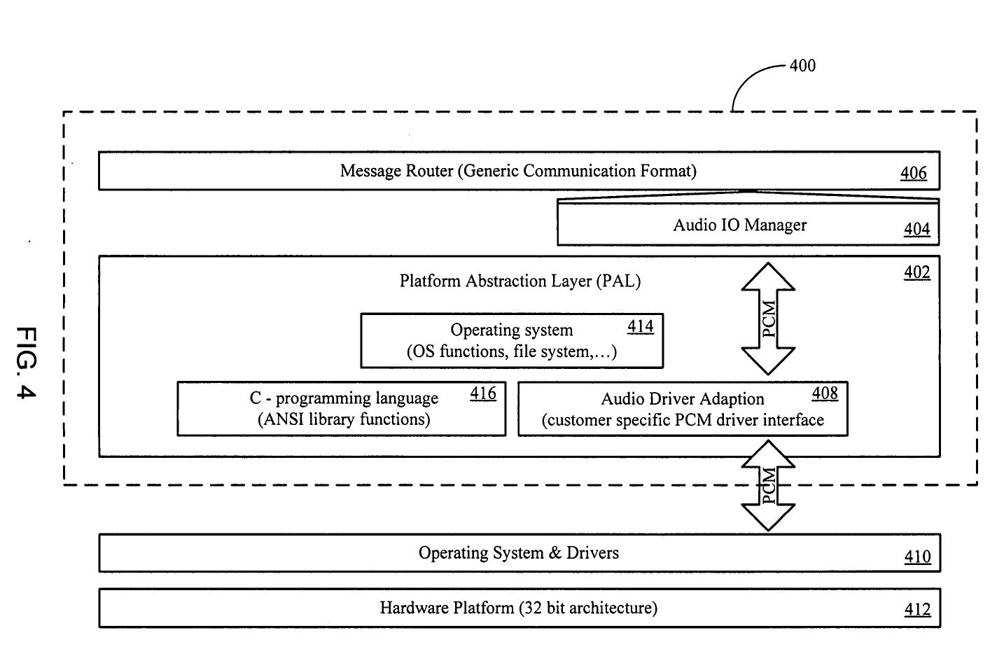

FIG. 4 is a portion of an integrated speech dialog system 400 that may facilitate adaptation to a customer specific pulse code modulation (PCM) driver interface. The integrated speech dialog system 400 may including a PAL 402, audio input/output manager 404, and GCF message router 406. PCM may represent a common method for transferring analog information through a stream of digital bits. The PAL 402 may allow for adaptation to particular specifications, such as the bit representation of words, of a customer specific PCM. The PAL may include customer specific PCM driver interface 408 for communication with a customer device driver.

All dependencies of software components of the integrated speech dialog system 400 on customer devices or applications, such as an audio device, are handled by the PAL 402. Adaptation to the target system is achieved by adapting the functions of the PAL 402 to the actual environment. In some systems the PAL 402 is adapted to the operating system and drivers 410 implemented on a hardware platform 412.

The audio input/output manager 404 may represent a constituent of the kernel of the integrated speech dialog system 400 that is connected to one or more service components through the GCF message router 406. Adaptation to a specific customer audio driver may be performed within the PAL 402 that comprises operating system functions and file system management 414. The PAL 402 may include an ANSI library function 416 that provides almost a full scope of the C-programming language, and an audio driver adaptation function that may include the customer specific PCM driver interface 408.

A customer audio device driver may use a customer specific PCM. The PAL 402 adapts the customer specific PCM to the inherent PCM used for the data connection between the PAL 402 and the audio input/output manager 404 of the integrated speech dialog system 400. In this manner, the PAL 402 may establish a platform independent, and highly portable, integrated speech dialog system 400.

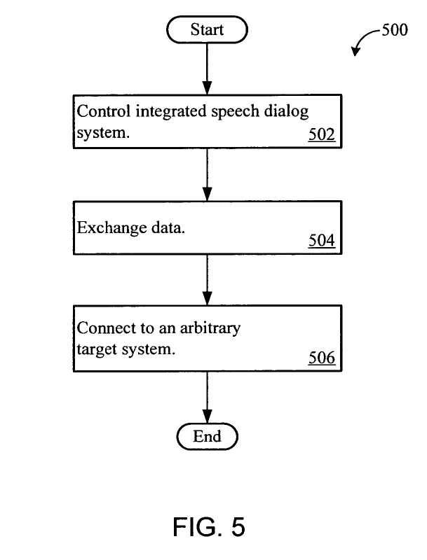

FIG. 5 is a process 500 involved in the operation of an integrated speech dialog system. The SAM 210 controls the integrated speech dialog system 200 (Act 502). The integrated speech dialog system 200 interfaces the SAM 210 with the message router 234 (Act 502). To control operation of the integrated speech dialog system 200, the SAM 210 may use the information provided in the service; registry 236. The service registry 236 may include information that associates the appropriate service components with a database, startup and shutdown information on service components 212-232, or other information. Some information may be related to the operation of one or more of service components 212-232.

The integrated speech dialog system 200 facilitates the exchange of data between service components 212-232 and/or between the SAM 210 and service components 212-232 (Act 504). The message router 234 facilitates a data exchange. The multiple service components 212-232, in communication with the message router 234, may use standardized, uniform, and/or open interfaces and communication protocols to communicate with the message router 234. These protocols may increase the extensibility of the integrated speech dialog system 200. The message router 234 may use a GCF for routing data. The message router 234 may communicate with multiple output channels. The message router 234 may receive data from a message channel corresponding to service components 212-232 and may republish or transmit the data to another message channel based on programmed or predetermined conditions.

The integrated speech dialog system 200 communicates the data to one or more target systems, or to one or more user application running on a target system (Act 506). The PAL 202 facilitates communication between the integrated speech dialog system 200 and one or more target systems. The PAL 202 may adapt the PCM of the target system to the inherent PCM used by the integrated speech dialog system 200 for communication between the PAL 202 and the audio input/output manager 224. The PAL 202 may facilitate a platform independent interface between the integrated speech dialog system 200 and the target system.

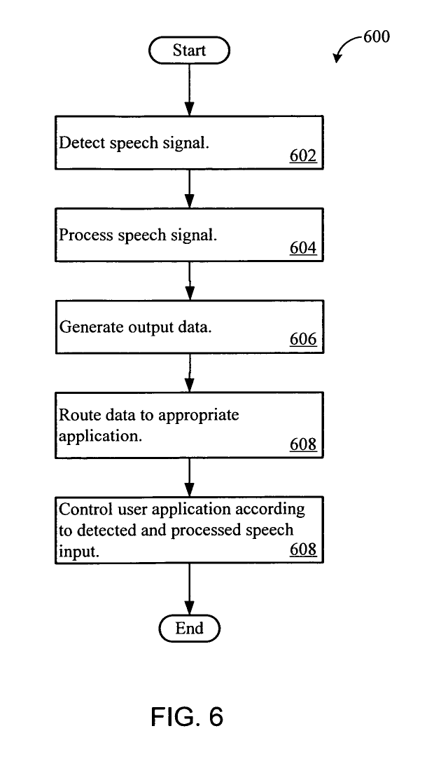

FIG. 6 is a process 600 in which an integrated speech dialog system may control one or more user applications or devices. The integrated speech dialog system 200 detects a speech signal (Act 602). Voice detection and/or recognition components, or other service components, which may be controlled by the SAM 210, may facilitate speech signal detection. The detected speech signal may comprise a signal detected by a microphone or one or more devices that convert an audio signal into an electrical signal. The integrated speech dialog system processes the speech signal (Act 604). The processing may include executing one or more speech signal processing operations related to the detected speech signal.

The integrated speech dialog system 200 generates output data based on the processes speech signal (Act 606). The output data may comprise a speech command, a sound, visual display, or other data. The output data may comprise a synthesized speech signal output. The output data may alert the user that the speech signal was unrecognizable. The integrated speech dialog system 200 routes the output data to the appropriate application (Act 608). The routing process may include routing instructions or commands to a device, software program, or other application. The PAL 202 may mediate routing of the instructions or commands.

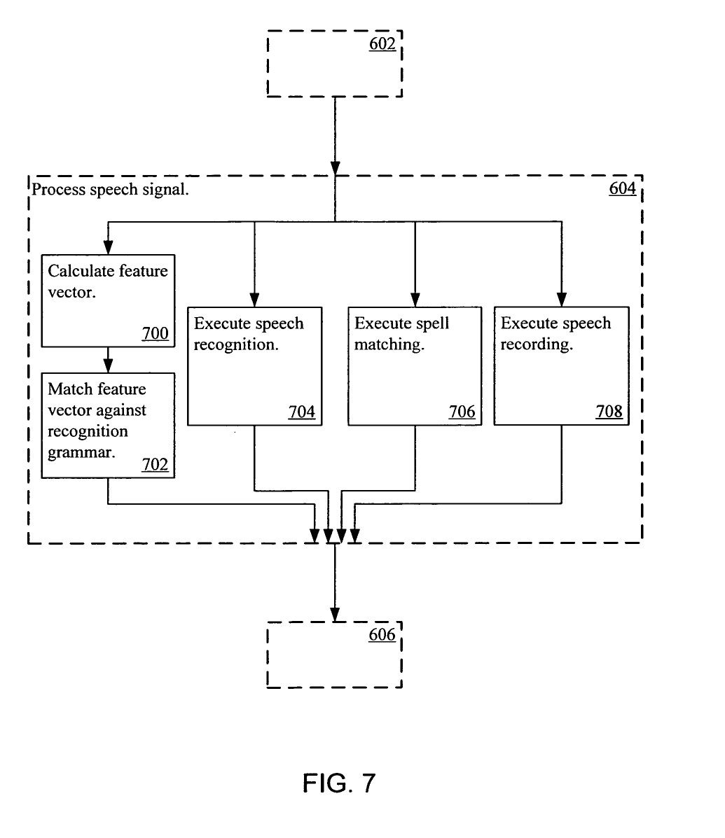

FIG. 7 is a process 700 that the integrated speech dialog system 200 may execute when processing (Act 604 shown in FIG. 6). The processing process may calculate feature vectors of the speech signal (Act 700). Feature vectors may include parameters relating to speech analysis and syntheses. The feature vectors may comprise cepstral or predictor coefficients. The processing process may include matching the feature vector with a recognition grammar to determine whether a command or other input was spoken (Act 702). The processing process may execute speech recognition operations (Act 704), spell matching operations (Act 706), speech recording operations (Act 708), and/or speech signal processing operations. The processing process may include any combination of acts 700-708 or other speech signal processing operations.

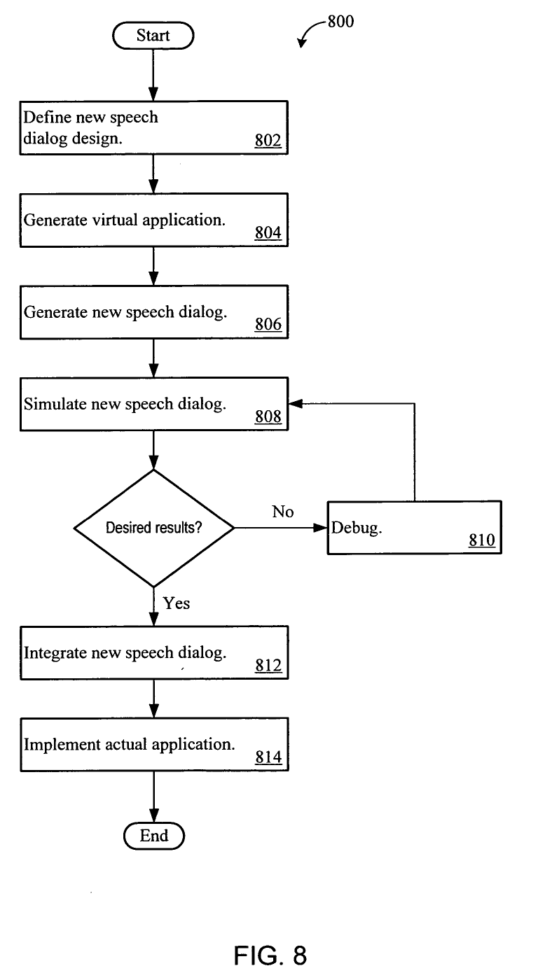

FIG. 8 is a process 800 in which an integrated speech dialog system may develop and simulate new speech dialogs. The development and simulation may be performed through the development and simulation environments. While the process 800 show functions performed by one or more of the development and simulation environments (e.g., 302 and 304), the integrated speech dialog system 300 may perform the functions of each environment separately. The employment of the development environment 302 may not require employment of the simulation environment 304. The new speech dialog may correspond to a CD player, DVD player, navigation unit, and/or other application. The integrated speech dialog system 300 provides efficient, adaptive, and easy development of new speech dialogs.

A new speech dialog to be developed is defined (Act 802). The definition may be performed through user programming, automatic software control, or other entered methods. The DDS 306 may perform the defining step. The integrated speech dialog system 300 generates a virtual application for development and simulation of the new speech dialog (Act 804). The parameters of the virtual application may be manually input by a user or through software, or may be compiled by the DDS 306. The DDS 306 may also compile the new speech dialog (Act 806). The new speech dialog may be compiled based on the definitions established according to Act 802

The integrated speech dialog system 300 may simulate control of the virtual application by the new speech dialog (Act 808). The simulation environment 304 may perform the simulation. The simulation may assist in verifying whether the new speech dialog is suitable for controlling the actual application by monitoring how it controlled the virtual application. If the new speech dialog does not exhibit the desired results during simulation, the integrated speech dialog system 300 may debug the speech dialog (Act 810) and then simulate the debugged speech dialog according to Act 606.

If the virtual application operates as expected during simulation, the integrated speech dialog system 300 may integrate the new speech dialog (Act 812). The actual user application may be implemented (Act 814). The implementation may include replacing the virtual application, with the actual user application. This may occur through installation of the actual user application into a target system or interfacing with the integrated speech dialog system 300.

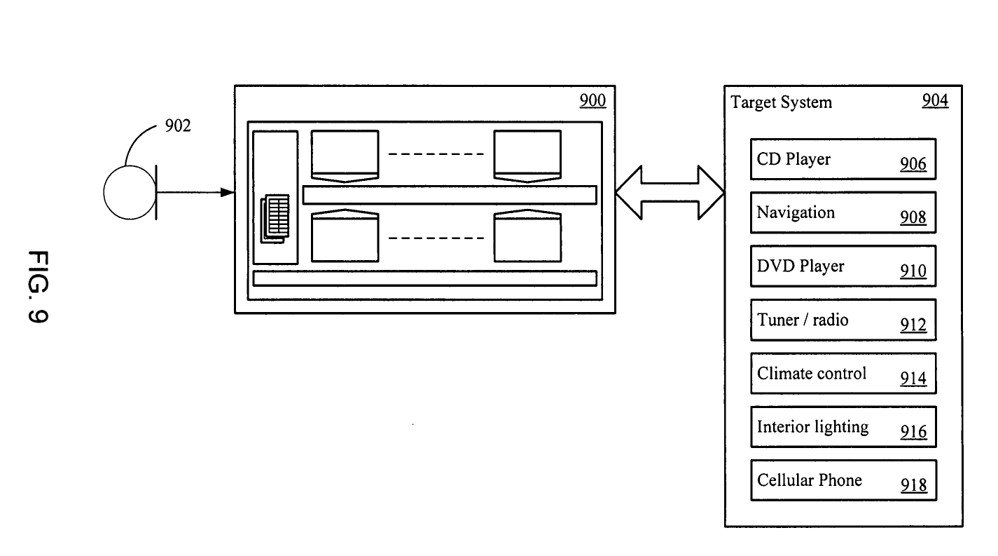

FIG. 9 is an integrated speech dialog system 900 coupled to a speech detection device 902 and a target system 904. The integrated speech dialog system 900 may detect an audio signal. The target system 904 may include one or more user applications. A vehicle user application may include a CD player 906, navigation system 908, DVD player 910, tuner 912, climate control 914, interior lighting 916, wireless phone 918, and/or other applications. The target system 904 may comprise hardware, an operating system, a device driver, and/or other platforms that applications may operate.

The integrated speech dialog system 900 may detect a speech signal through a speech detection device 902, such as a microphone, or a device that converts audio sounds into electrical energy. The integrated speech dialog system 900 may process the detected audio signal, generate output data, route the output data to the appropriate application, and control the application based on the detected and processing speech signal. Through one or more of these functions, one or more user applications may be controlled by a user's speech commands.

FIG. 9 shows the integrated speech dialog system coupled to a single target system 904. Alternatively, the integrated speech dialog system may be coupled to multiple target systems. Due to the abstraction of platform dependencies, the integrated speech dialog system 900 may be coupled or in communication with multiple target systems having a variety of platforms. The abstraction of dependencies also enables any new target systems to be readily coupled to the integrated speech dialog system 900, thus providing a highly portable, adaptable, and extensible speech dialog system.

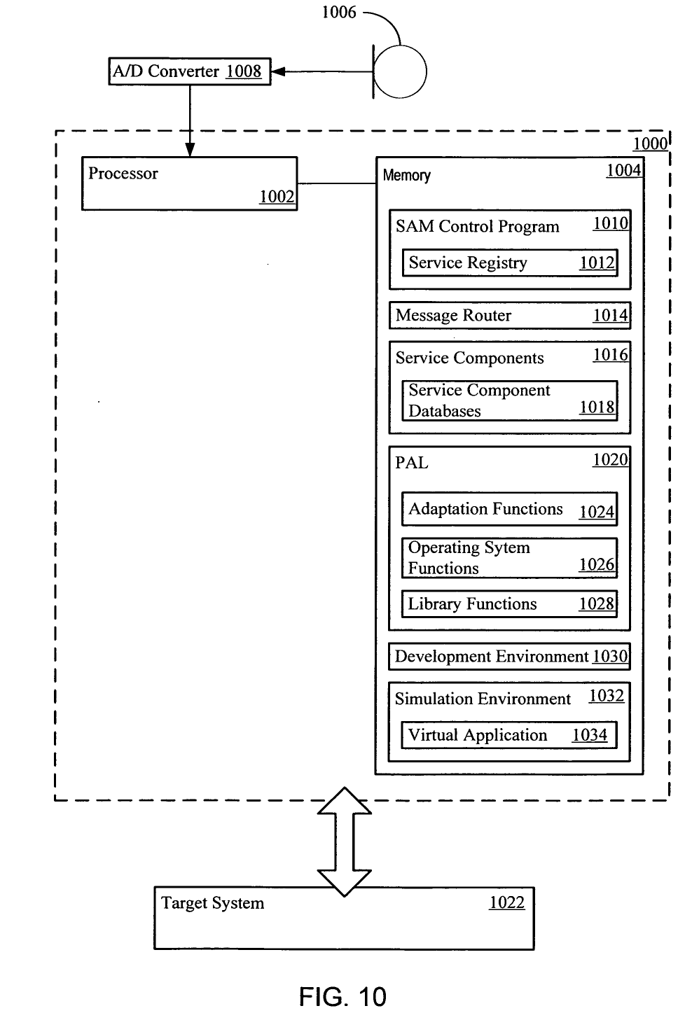

FIG. 10 is an integrated speech dialog system 1000 including a processor 1002 and a memory 1004. The memory may be A speech detection device 1006, such as a microphone, may connect to the processor 1002 via an anolog-to-digital converter (A/D converter) 1008. The processor 1002 receives a speech input signal from an A-to-D converter 1008. The A-to-D converter 1008 may be part of or may be separate from the processor 1002.

The processor 1002 may execute a SAM control program 1010 controlling the operation of the integrated speech dialog system 1000. The SAM control program 1010 may include a service registry 1012 that provides instructions related to the operation of the integrated speech dialog system 1000. For example, the service registry 1012 may include instruction related to startup and shutdown of multiple service components 1014. As another example, the service registry 1012 may include instruction related to the association of one or more service component databases 1016 with the appropriate service components 1014.

The processor 1002 may execute instructions related to the operation of a message router 1018. The message router 1018 may communicate with multiple output channels. The message router 1018 may receive a message or data from one of the multiple service components 1014 and republish or transmit it to a certain message channel depending on set of conditions. These conditions may be defined in the service registry 1012 or in another location, or as part of an instruction set, related to operation of the multiple service components 1014.

The processor 1002 may execute instructions related to operation of the multiple service components 1014, as well as the service component databases 1016 used by the multiple service components 1014 to perform their respective speech signal processing operations. The processor 1002 executes instructions related to operation of the PAL 1020 to facilitate platform independent porting of the integrated speech dialog system 1000 to an arbitrary target system 1022.

Operation of the PAL 1020 includes adaptation functions 1024 that adapt the integrated speech dialog system 1000 to the target system 1022 without requiring modification of the kernel of the integrated speech dialog system 1000. The processor 1002 may execute the PAL 1020 and may adapt a customer specific PCM to the inherent PCM used by the integrated speech dialog system 1000. The PAL 1020 may include operating system functions and file system management 1026 and library functions 1028 to provide the full scope of the C-programming language.

The processor may execute instructions related the operation of a development environment 1030. The development environment 1030 provides seamless development of new speech dialogs associated with new or modified user requirements. The development environment 1030 may include instructions and databases associated with the elements of the development environment 302 shown in FIG. 3. The processor may also execute instructions related to operation of a simulation environment 1032 for simulating a new speech dialog. The simulation environment 1030 may include the specifications of a virtual application 1034. The simulation environment 1032 may simulate the new speech dialog in connection with the virtual application 1034 to determine whether the new speech dialog operates as expected.

Although selected aspects, features, or components of the implementations are depicted as being stored in memories, all or part of the systems, including methods and/or instructions for performing methods, consistent with the integrated speech dialog system may be stored on, distributed across, or read from other machine-readable media, for example, secondary storage devices such as hard disks, floppy disks, and CD-ROMs; a signal received from a network; or other forms of ROM or RAM either currently known or later developed.

Specific components of an integrated speech dialog system may include additional or different components. A processor may be implemented as a microprocessor, microcontroller, application specific integrated circuit (ASIC), discrete logic, or a combination of other type of circuits or logic. Similarly, memories may be DRAM, SRAM, Flash or any other type of memory. Parameters (e.g., conditions), databases, and other data structures may be separately stored and managed, may be incorporated into a single memory or database, or may be logically and physically organized in many different ways. Programs and instruction sets may be parts of a single program, separate programs, or distributed across several memories and processors.

While the integrated speech dialog system is described in the context of a vehicle, such as a navigation system or CD Player, the integrated speech dialog system may provide similar services to applications in the portable electronic, appliance, manufacturing, and other industries that provide speech controllable services. Some user applications may include telephone dialers or applications for looking up information in a database, book, or other information source, such as the applications used to look up information relating to the arrival or departure times of airlines or trains.

While various embodiments of the invention have been described, it will be apparent to those of ordinary skill in the art that many more embodiments and implementations are possible within the scope of the invention. Additionally, mechanical devices may be controlled by speech input via the integrated speech dialog system. Accordingly, the invention is not to be restricted except in light of the attached claims and their equivalents.

I claim:

1. An integrated speech dialog system, comprising
a speech application manager;
a message router in communication with the speech application manager;
a plurality of service components in communication with the message router; and
a platform abstraction layer interconnecting the integrated speech dialog system with an arbitrary target system.

2. The integrated speech dialog system of claim 1, where the message router comprises a uniform generic communication format to provide data exchange between at least two of the plurality of service components.

3. The integrated speech dialog system of claim 1, where the speech application manager comprises a service registry.

4. The system of claim 1, where the plurality of service components comprise at least one of a customer programming interface, voice detection component, voice prompting component, text synthesis component, recorder component, spell matcher component, configuration database, debug and trace service, host agent, audio input/output manager and codecs, or general dialog manager.

5. The integrated speech dialog system of claim 1, further comprising a development environment.

6. The integrated speech dialog system of claim 5, where the development environment comprises a user interface.

7. The integrated speech dialog system of claim 5, where the development environment comprises a dialog development tool.

8. The integrated speech dialog system of claim 1, further comprising a simulation environment.

9. The integrated speech dialog system of claim 1, further comprising a speech dialog that controls a user application based on speech.

10. The integrated speech dialog system of claim 1, where the user application comprises an electronic system in a vehicle.

11. A method that operates a speech dialog system comprising:
controlling an integrated speech dialog system through a speech application manager;
exchanging data between a plurality of service components and between the plurality of service components and the speech application manager through a message router; and
connecting the integrated speech dialog system to an arbitrary target system through a platform abstraction layer.

12. The method of claim 11, where the data exchanged by the message router is formatted in a uniform generic communication format.

13. The method of claim 11, where the plurality of service components comprises at least one of a customer programming interface and voice detection component.

14. The method of claim 11, further comprising
detecting a speech signal;
processing the detected speech signal;
generating output data based on an analysis of the processed speech signal;
routing the output data to a user application, where the routing is managed by the platform abstraction layer.

15. The method of claim 14, where the processing comprises at least one of converting the detected speech signal into a feature vector, a speech recognizing feature, a spell matching feature, or a speech recording feature.

16. The method of claim 11, where the output data comprises a synthesized speech signal.

17. The method of claim 11, further comprising developing a new speech dialog using a development environment.

18. The method of claim 17, developing comprising:
defining a new speech dialog;
generating the new speech dialog;
debugging the new speech dialog; and
integrating the new speech dialog into the integrated speech dialog system where the desired results are achieved.

19. The method of claim 18, further comprising:
simulating the new speech dialog;
determining whether the simulation produced desired results; and
debugging where the desired results were not achieved.

20. The method of claim 11, further comprising simulating a new speech dialog using a simulation environment.

21. The method of claim 20, further comprising:
determining whether the simulation produced desired results; and
debugging the new speech dialog when desired results were not achieved.

22. The method of claim 21, further comprising repeating the simulating, determining, and debugging acts until the desired results are achieved.

23. A product comprising:
a machine readable medium; and
instructions on the medium that cause a processor in an integrated speech dialog system to:
control the integrated speech dialog system by a speech application manager;
exchange data between a plurality of service components and between the plurality of service components and the speech application manager through a message router; and
connect the integrated speech dialog system to an arbitrary target system though a platform abstraction layer.

24. The product of claim 23, where the data exchanged by the message router is formatted in a uniform generic communication format.

25. The product of claim 23, further comprising instructions on the medium that cause the processor to:
detect a speech signal;
process the detected speech signal;
generate output data based on an analysis of the processed speech signal;
transmit the output data to an application, where a data routing is managed by the platform abstraction layer.

26. The product of claim 25, where the processing instructions comprise at least one of converting the detected speech signal into a feature vector, speech recognizing, spell matching, and/or speech recording.

27. The product of claim 25, where the output data comprises a synthesized speech signal generated by the integrated speech dialog system.

28. The product of claim 23, further comprising instructions on the medium that cause the processor to develop a speech dialog using a development environment.

29. The product of claim 23, further comprising instructions on the medium that cause the processor to:
define a new speech dialog;
generate the new speech dialog;
debug the new speech dialog where the desired results were not achieved; and
integrate the new speech dialog into the integrated speech dialog system where the desired results are achieved.

30. The product of claim 23, further comprising instructions on the medium that cause the processor to simulate applications or devices using a simulation environment.

31. The product of claim 30, the simulating comprising:
determining whether the simulation produced desired results; and
debugging the new speech dialog where desired results were not achieved.

32. An integrated speech dialog system comprising:
a speech application manager that controls the integrated speech dialog system;
a message router in communication with the speech application manager, the message router using a uniform generic communication format to provide a data exchange;
a plurality of service components in communication with the message router;
a platform abstraction layer interconnecting the integrated speech dialog system with an arbitrary target system;
a development environment that develops a new speech dialog; and
a simulation environment that simulates the new speech dialog.

33. The integrated speech dialog system of claim 32, where the development environment comprises debugging software.

34. The integrated speech dialog system of claim 32, where the development environment comprises a compiler that generates the new speech dialog.
